(19) United States
(12) Patent Application Publication
(10) Pub. No.: US 2010/0185315 A1
(43) Pub. Date: Jul. 22, 2010

(54) ROBOT TOOL, ROBOT SYSTEM AND METHOD FOR MACHINING WORKPIECES

(75) Inventors: Peter G. SCHMIDT, Bad Nauheim (DE); Guy Feltz, Waldsolms (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AB, Vaesteras (SE)

(21) Appl. No.: 12/713,889

(22) Filed: Feb. 26, 2010

Related U.S. Application Data
(63) Continuation of application No. PCT/EP2008/006550, filed on Aug. 8, 2008.

(30) Foreign Application Priority Data
Aug. 31, 2007 (DE) 10 2007 041 423.6

(51) Int. Cl. B25J 13/08; B25J 15/06; B25J 19/04

(52) U.S. Cl. 700/160; 700/259; 700/179; 700/258; 700/174; 901/41; 901/40; 901/31

(57) ABSTRACT

A robot tool for machining workpieces, includes a connecting element for connection to a robot. A cutting blade is maintained in a predetermined position by a retaining element, the retaining element being connectible to the robot by a connecting element.

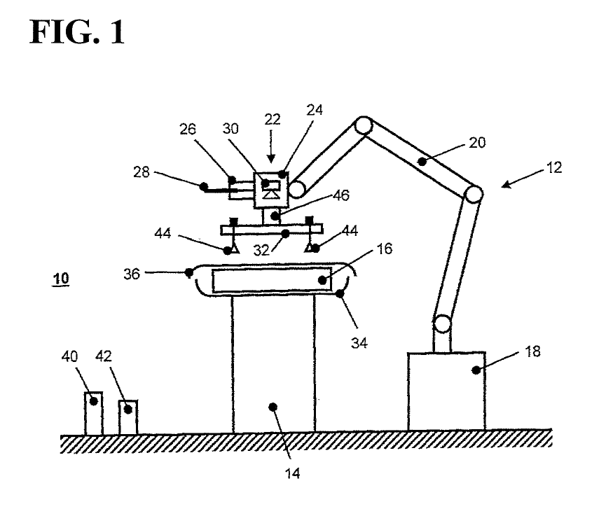

### RELATED APPLICATIONS

This application claims priority as a continuation application under 35 U.S.C. §120 to PCT/EP2008/006550, which was filed as an International Application on Aug. 8, 2008 designating the U.S., and which claims priority to German Application 10 2007 041 423.6 filed in Germany on Aug. 31, 2007, the entire contents of which are hereby incorporated by reference in their entireties.

### FIELD

The disclosure relates to robot tools for processing of workpieces, robot systems, and methods for processing of workpieces.

### BACKGROUND INFORMATION

Robot tools for processing of workpieces are known in a wide range of applications, for example for painting, welding or adhesive bonding. However, fields of application also exist in which the processing of workpieces is not carried out by robots but is coped with manually by appropriate personnel.

For example, a protection projection beyond the boundary of a workpiece, for example a protective sheet which is adhesively bonded over an LCD display, may be removed manually with a sharp blade, such as by cutting it off manually with an appropriate knife. Knives such as these can become blunt comparatively quickly, and accordingly may frequently have to be replaced. Furthermore, there is an acute risk of injury in a situation in which the blades break off during the cutting process.

### SUMMARY

A robot tool is disclosed for processing a workpiece. An exemplary robot tool includes a first connecting element for connecting to a robot; a holding element, connected to the connecting element for holding a cutting blade in a predetermined position when the first connecting element is connected to the robot; and a gripping apparatus detachably connected to the holding element.

A robot system is disclosed for processing a workpiece. An exemplary robot system includes a robot and a robot tool which includes a first connecting element for connecting to a robot; a holding element, connected to the connecting element, for holding a cutting blade in a predetermined position when the first connecting element is connected to the robot; and a gripping apparatus detachably connected to the holding element.

An exemplary method for processing a workpiece using a robot tool connected to a robot, a cutting blade held in a predetermined position by a holding element, and a gripping apparatus connected to the holding element, includes holding a workpiece to be processed with the holding apparatus; moving the gripping apparatus to a predetermined position on a table; and moving the cutting blade along a predetermined movement path to process the workpiece.

### BRIEF DESCRIPTION OF THE DRAWINGS

The disclosure, advantageous refinements, improvements of the disclosure, and further advantages will be explained and described in more detail with reference to the exemplary embodiment which is illustrated in the drawing, in which:

The single FIGURE shows an exemplary robot system.

### DETAILED DESCRIPTION

An exemplary robot tool, an exemplary robot system and an exemplary method for processing of workpieces, are disclosed herein by which processing can, for example, be carried out more quickly and more exactly than in the past.

An exemplary robot tool as disclosed herein includes a cutting blade that can be held in a predetermined position (e.g., a position established by a user) by a holding element. The holding element can be connected to the robot by the connecting element.

This can result in an exemplary robot tool which carries out exact cutting tasks, as part of workpiece processing. This is because, for example, the cutting blade can be held in a predetermined position and can be used in conjunction with the robot, with the accuracy of the robot movement.

An exemplary robot tool as disclosed herein can have a cutting blade changer.

This can ensure that any cutting blades which may have become blunt can be replaced in a simple manner, or can easily be replaced on a periodic basis (for example, after a certain usage time).

An exemplary robot tool as disclosed herein can have a test apparatus for the cutting blades.

This can allow the cutting blade which is currently in use to still be used while it is still of a predetermined sharpness. It can then be replaced as appropriate when, for example, the cutting blade is found to be unusable.

An exemplary robot tool as disclosed herein can have the cutting blade connected in a sprung manner to the holding apparatus.

This can advantageously result in tolerance compensation. If, for example, the sprung holder is acting in one spatial direction, then uneven features on a cutting edge or material thickness changes on the workpiece to be cut, or other unpredictable events, can be compensated for particularly easily.

The cutting performance can be advantageously improved by having the cutting blade of an exemplary robot tool be a hot blade.

An exemplary robot tool as disclosed herein includes a further connecting element that can be provided on the holding apparatus.

This can result in the capability to integrate a further processing appliance with the holding apparatus, and thus on an exemplary robot tool. A further processing appliance such as this can be, for example, a second cutting blade with the advantage that a second cutting blade can be available particularly quickly when required. However, it is also feasible to connect other appliances or apparatuses, for example a suction apparatus or measurement apparatuses, without any problems.

In an exemplary robot tool, a gripping apparatus can be connected, for example, detachably connected, to the holding element.

An exemplary robot tool can use the gripping apparatus to first move the workpiece to be processed to a predetermined processing position and then, without any need for a second robot or even a tool change on the relevant robot, to start processing of the workpiece immediately. When, for example, the gripping apparatus is detachably connected to the holding element, the exemplary robot tool can leave the gripping apparatus on the workpiece. This allows the workpiece to be picked up again later in a particularly simple manner.

In an exemplary robot tool, the holding element may have a sensor, such as an optical or laser-based sensor, or any other suitable sensor.

This can allow the exemplary robot tool to use the sensor, for example a digital camera, to record an image of its environment and in this way to identify its environment by analysis of the image, in the process making it possible to take account of possible obstructions in the movement path.

The sensor can also be used for verification purposes, at least by a previously predetermined reference point or a reference edge line, or the like on a workpiece to be processed or in the working area of the robot.

A desired position and orientation of the workpiece can be processed to be determined or to be confirmed in a particularly simple manner. By way of example, verification can be carried out by searching for the reference point at an expected or planned point on the workpiece. If the reference point cannot be found there, search movements can be carried out around the expected position to search for the actual reference point, for example a marker that has been applied or a typical point on the workpiece.

The sensor can measure the workpiece overall. Furthermore, the sensor can be used to identify the position and orientation of the workpiece and, if necessary, can be used to correct a movement programme for the robot, using the identified position and orientation.

This can also allows slight discrepancies in the position of the workpieces in their workpiece holder to be corrected as desired, that is to say, for example, individually for the respective processing process.

An exemplary robot system can include at least one of the exemplary robot tools according to the disclosure, and can achieve advantages mentioned above.

An exemplary robot system can include a blade changer arranged in the working area of the robot, and an exemplary robot tool can interact with the blade changer when desired.

An exemplary robot tool can be relieved of the function of blade replacement and can accordingly be made simpler.

A corresponding situation applies to the design of an exemplary robot system with a blade tester, which can be arranged in the working area of the robot and interact with an exemplary robot tool as desired.

An exemplary method for processing of workpieces using an exemplary robot tool can move a cutting blade along a predetermined movement path by an exemplary robot system.

The exemplary method for processing of workpieces using a robot tool can achieve uniformity and repeatability of processing, and therefore a correspondingly high quality level. Furthermore, the cutting speed can be optimized as appropriate to the blades that are used, and this can lead to considerably better cutting performance. Furthermore, the working area of the robot can be a safety zone in which no operator may be located during operation of the robot. This therefore can preclude from the start the otherwise normal possibilities of injury or danger to people such as these.

An exemplary method for processing of workpieces using a robot tool can use a sensor to determine a reference point for a starting point of the predetermined movement path.

This can ensure verification of the predetermined movement path or correction of the predetermined movement path as appropriate for the individual position and orientation of the workpiece currently to be processed, in a particularly simple manner.

In order to improve the cutting quality, an exemplary method for processing of workpieces using a robot tool can include testing the condition of the cutting blade before and/or after each cut (for example breakage, bending, etc).

This can allow predetermined quality standards to be implemented in a particularly simple manner.

The single FIGURE shows an exemplary robot system 10 with a robot 12, a workpiece table 14 on which a workpiece 16 is arranged. In the illustrated example, the robot 12 has a robot foot 18 and a robot arm, such as a multi-axis robot arm 20 which is fitted with a combination tool 22 at its free end. In this example, the combination tool 22 can be firmly connected to a connecting element, such as a flange which can be attached and/or formed at a desired position of the robot arm 20, so that the robot 12 determines both the spatial position and the alignment of the combination tool 22 by simple movement.

The combination tool 22 is connected to the robot arm 20 by a holding element 24 for holding the tool in a predetermined position (e.g., a position established in advance by a user) when the connection flange is connected to the robot 12. The holding element 24 can be used as a basic element for a blade holder 26 in which a blade 28 is clamped, for a sensor system 30 and for a suction gripping apparatus 32. The holding element 24 can be firmly connected to all these components 26, 30, 32.

The combination tool 22 is illustrated in this FIGURE in such a way that the suction gripping apparatus 32 is arranged directly opposite the tool 16 to be processed, with this tool 16 having already been placed in a workpiece holder 34 on the tool table 14, which is positioned on the ground. Furthermore, the suction gripping apparatus 32 is at a distance from the workpiece 16 in the illustrated FIGURE. A protective sheet 36 can be connected to a relevant side of the workpiece 16, on the side of the workpiece 16 facing away from the workpiece table 14. In this example, the workpiece 16 is intended to be a solar module which has been produced from an arrangement of a multiplicity of individual solar cells, with the protective sheet 36 being intended to be used as protection for the solar cells for other processing steps as well as for any subsequent transport. In the illustrated example, however, this protective sheet 36 is even larger than the relevant surface of the workpiece 16, so that the task for the robot with its tool is to cut off the protective sheet along the edges bounding the surface, as close as possible to these edges.

A blade tester 40 and a blade changer 42 are also shown on the ground alongside the tool table 14, in a working area of the robot. This makes it possible for the robot 12 to check the condition of the cutting blade during the processing of the workpiece 16, before or after, each processing operation on a workpiece, and if necessary, to carry out a blade replacement. It is also within the disclosure for appliances 40, 42 such as these to be arranged in an appropriately adapted form on the holding base element 24 of the combination tool 22 itself. This can avoid the need for the various robot arm movements which are desired in order to reach the blade tester 40 or the blade changer 42.

The example shows a cold blade. However, it is equally possible to use hot blades as well, as are known by those skilled in the art. This can increase the life of the blades.

The example shows that the processing of the workpiece 16 by the combination tool 22 with the robot 20 and further components 40, 42, 14 relating to an exemplary robot system 10 ensures that workpieces can be processed particularly quickly and reliably.

Using the illustrated robot system 10, an exemplary method according to the disclosure for processing of the workpiece 16 can be carried out with the combination tool 22 as follows. First, the robot approaches a handover station for unprocessed workpieces. There, the suction gripping apparatus 32 is moved to a position above the next workpiece to be processed, to a similar position to that shown in this FIGURE, for example, immediately above one side of the workpiece which is fitted with the protective sheet. The FIGURE shows a side view of the suction gripping tool 32, so that this view shows only a first and a second suction gripper 44. One suction gripper can be adequate depending on the objective, the shape and the size of the workpiece, although a considerably greater number of suction grippers 44 can be desired. For example, six or more (or less) suction grippers 44 may be used in order to maintain a safe grip on a solar module, and also to transport it. The robot now moves the suction gripping apparatus 32 until the suction grippers 44 rest on the surface of the workpiece 16. The suction grippers 44 are then operated so as to produce a suction effect, with the workpiece 16 adhering to the suction gripping apparatus.

The robot can now move the workpiece 16 from the transfer position to a point above the tool table 14. In a further robot movement, the workpiece 16 is placed in the holding apparatus 34 on the tool table 14, and the suction effect of the suction gripping apparatus 32 is switched off, so that it is now decoupled or released from the workpiece 16.

By way of example, as an alternative to this procedure, a connecting element 46 between the suction gripping apparatus 32 and the base element 24 can be designed as a disengagable or operable coupling such that a robot controller or a tool controller decouples or uncouples the suction gripping apparatus 32 from the base element 22 as desired. For example, as soon as the workpiece 16 is positioned in the workpiece holder 34, the suction gripping apparatus 32 remains on the workpiece as a result of the connection to the suction grippers 44 and the workpiece, with the complete suction gripping apparatus being completely decoupled by decoupling the coupling on the intermediate piece 46.

The robot tool 22 is now able to carry out further processing steps using different apparatuses. First the sensor system, for example a camera 30, can be moved by an appropriate combination tool/robot movement to a position above the workpiece 16, so that the sensor system can measure the entire workpiece. The exact position of the workpiece 16 in its workpiece holder 34 can be determined on the basis of the measurement points and, in addition, a reference point can be calculated and used to define, to correct and to verify the starting point of the cutting movement by the blade 28, exactly and individually for this workpiece to be processed at that time, in its current position.

The cutting blade 28 can first be moved to the blade tester 40 by a suitable change in the position of the combination tool 22, where it is moved to a test position such that the appliance can test the blade. For example, it is assumed that the blade has been worn and that the robot now moves the combination tool 22 to the blade changer 42, in which the blade is replaced. However, the sharpness test and/or the blade replacement can be carried out on appropriate appliances on the combination tool 22 itself, which is then designed appropriately. The robot moves the blade 28 to its starting position in the area close to the workpiece 16. During this positioning, care is taken to ensure that the movement path of the blade 18 has a profile which is technically as optimum as possible for the cutting of the protective sheet 36, so that the cutting speeds, cutting angles, and so forth are complied with. Comparatively minor disturbances in the movement process of the blade 18 which result, for example, from dimensional inaccuracies of the workpiece 16 on the edge to be cut, can be compensated for by an appropriate compensation apparatus. The blade can be mounted in a sprung (e.g., extended) manner, for example, in a compensation apparatus such as this, for example, at right angles to the cutting movement of the blade cutter. In the chosen example, the movement path for cutting the protective sheet 36 runs along the edges on which the protective sheet 36 projects beyond the workpiece 16 including four individual straight-line movement elements, so that, once these four movement elements have been completed, the process has moved around the edges once.

After the end of the cutting process, the robot arm 20 of the combination tool 22 moves back to a position approximately above the workpiece 16, in such a way that the sensor 30 can record a further image of the workpiece 16. A quality check of the cut can be carried out by an appropriately designed image processing system and, if the cut quality is adequate, the workpiece 16 is picked up again by the suction gripping apparatus 22, and is moved from the workpiece table 14 to a transfer position for processed workpieces.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Robot tool for processing a workpiece, comprising:
a first connecting element for connecting to a robot;
a holding element, connected to the connecting element, for holding a cutting blade in a predetermined position when the first connecting element is connected to the robot; and
a gripping apparatus detachably connected to the holding element.

2. Robot tool according to claim 1, wherein the holding element comprises:
a cutting blade changer.

3. Robot tool according to claim 1, wherein the holding element comprises:
a blade tester for the cutting blade.

4. Robot tool according to claim 1, comprising:
a cutting blade held in a sprung manner to the holding apparatus.

5. Robot tool according to claim 1, comprising:
a cutting blade heated during a cutting operation.

6. Robot tool according to claim 1, wherein the holding element comprises:
a second connecting element.

7. Robot tool according to claim 1, wherein the holding element controls connection of the gripping apparatus to the holding element.

8. Robot tool according to claim 1, wherein the gripping apparatus comprises:
at least one suction grip.

9. Robot tool according to claim 1, wherein the holding element comprises:
at least one of an optical and laser-based sensor.

10. Robot tool according to claim 1, comprising:
a sensor for verifying at least one of a previously predetermined reference point and a reference edge on at least one of a workpiece to be processed and a working area of a robot.

11. Robot tool according to claim 1, comprising:
a sensor for measuring the workpiece.

12. Robot tool according to claim 1, comprising:
a sensor for identifying a position and orientation of a workpiece to correct a movement program of the robot.

13. A robot system for processing a workpiece comprising:
a robot; and
a robot tool which includes:
a first connecting element for connecting to a robot;
a holding element, connected to the connecting element, for holding a cutting blade in a predetermined position when the first connecting element is connected to the robot; and
a gripping apparatus detachably connected to the holding element.

14. Method for processing a workpiece using a robot tool connected to a robot, a cutting blade held in a predetermined position by a holding element, and a gripping apparatus connected to the holding element, the method comprising:
holding a workpiece to be processed with the holding apparatus;
moving the gripping apparatus to a predetermined position on a table; and
moving the cutting blade along a predetermined movement path to process the workpiece.

15. Method according to claim 14, comprising:
determining a reference point by a sensor as a start of the movement path; and
measuring at least one of position, orientation and dimension of the workpiece using the sensor.

16. Method according to claim 14 comprising:
heating the cutting blade to a predetermined temperature before cutting.

17. Method according to claim 14 comprising:
testing a condition of the cutting blade at each cut.

18. Method according to claim 14 comprises:
replacing the blade based on a predetermined criterion related to at least one of the blade condition, usage time and cut length.

19. Robot tool according to claim 1, comprising:
a second connecting element for detachably connecting the gripping element to the holding element.

20. Method according to claim 15 comprising:
correcting the movement path based outputs of the sensor.
